(19) United States
(12) Patent Application Publication
(10) Pub. No.: US 2010/0128571 A1
(43) Pub. Date: May 27, 2010

(54) METHOD FOR CONTROLLING MORNING CALL OF MOBILE TERMINAL AND MOBILE TERMINAL USING THE SAME

(75) Inventors: Young-Gil ROH, Suwon-si (KR); Sung-Won JEON, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/578,302

(22) Filed: Oct. 13, 2009

(30) Foreign Application Priority Data
Nov. 27, 2008 (KR) 10-2008-0119176

(51) Int. Cl. G04G 13/02; G04B 47/06

(52) U.S. Cl. 368/11; 368/250

(57) ABSTRACT

A method for controlling a morning call function using a motion recognition sensor, and a mobile terminal using the same are provided. In the method, when a morning call alarm operates and a snooze function starts, a motion is detected using the motion recognition sensor. The detected motion is divided based on a preset time interval and each of the divided amounts of the detected motion is stored. Each of the divided amounts of the motion stored is determined so that whether to re-operate the morning call alarm is determined. Therefore, a user can wake up at a desired time.

### PRIORITY

This application claims the benefit under 35 U.S.C. §119(a) of a Korean patent application filed in the Korean Intellectual Property Office on Nov. 27, 2008 and assigned Serial No. 10-2008-0119176, the entire disclosure of which is hereby incorporated by reference.

### BACKGROUND OF THE INVENTION

1. Field of the Invention

The present invention relates to an apparatus and method for controlling a morning call function in a mobile terminal. More particularly, the present invention relates to an apparatus and method for controlling a morning call function using a motion recognition sensor of a mobile terminal.

2. Description of the Related Art

In a conventional mobile terminal, when a morning call alarm operates and a snooze function operates, the snooze function continues to operate as long as a user presses an END button. However, when the user presses the END button and goes back to sleep inadvertently, the snooze function terminates and the user cannot wake up at a desired time. Accordingly, recently, a motion recognition sensor such as an acceleration sensor or a gyro sensor is attached to a mobile terminal to control an alarm depending on the motion of the mobile terminal, so that the above-described limitation has been addressed. However, in a conventional control method, when an alarm rings and a key is input, a popup window opens again after a preset time, and when a key is input within a preset time, an alarm terminates. In this case, when a user inputs a key unconsciously and goes back to sleep inadvertently, a snooze function terminates and the user cannot wake up at a desired time.

### SUMMARY OF THE INVENTION

An aspect of the present invention is to address at least the above-mentioned problems and/or disadvantages and to provide at least the advantages described below. Accordingly, an aspect of the present invention is to provide a mobile terminal for, when a user performs a motion with the mobile terminal for a preset time, detecting the user's motion using a motion recognition sensor to maintain or terminate the operation of a morning call function.

According to an aspect of the present invention, a method for controlling a morning call operation of a mobile terminal is provided. The method includes, when a morning call alarm operates and a snooze function starts, detecting a motion using a motion recognition sensor, dividing the detected motion based on a preset time interval and storing each of the divided amounts of the detected motion; and determining each of the divided amounts of the detected motion stored to determine whether to re-operate the morning call alarm.

In an exemplary implementation, the determining of whether to re-operate the morning call alarm may include, when one of the divided amounts of the detected motion where no motion is present for a snooze time exists, determining an average of the divided amounts stored and comparing the average with a threshold value for the snooze time.

In an exemplary implementation, the determining of whether to re-operate the morning call alarm may include, when one of the divided amounts of the detected motion where no motion is present for the snooze time does not exist, terminating the morning call alarm.

In an exemplary implementation, the snooze function may be set or released by a user, and the snooze time may be set by the user.

According to an aspect of the present invention, a method for controlling a morning call operation of a mobile terminal is provided. The method comprises, when a morning call alarm of the mobile terminal rings and a snooze function starts, detecting a motion using a motion recognition sensor of an additional unit connectable with the mobile terminal via short range communication, dividing the detected motion based on a preset time interval and storing each of the divided amounts of the detected motion, determining each of the dived amounts of the detected motion stored for a snooze time to determine whether to re-operate the morning call alarm, and transmitting the determination as to whether to re-operate the morning call alarm to the mobile terminal.

According to an aspect of the present invention, a method for controlling a morning call operation of a mobile terminal is provided. The method comprises, when a morning call alarm of the mobile terminal rings and a snooze function starts, detecting a motion using a motion recognition sensor of an additional unit connectable with the mobile terminal via short range communication, transmitting the detected motion to the mobile terminal, dividing, by the mobile terminal, the motion transmitted from the additional unit based on a preset time interval and storing each of the divided amounts, and determining each of the divided amounts of the motion store d for a snooze time to determine whether to re-operate the morning call alarm.

According to another aspect of the present invention, a mobile terminal is provided. The mobile terminal includes a display unit for displaying a screen of the mobile terminal, a motion recognition sensor unit for, when a morning call alarm operates and a snooze function starts, detecting a motion of the mobile terminal using a motion recognition sensor, a memory for dividing the detected motion based on a preset time interval and storing each of the divided amounts of the detected motion; and a controller for determining each of the divided amounts of the detected motion stored to determine whether to re-operate the morning call alarm.

In an exemplary implementation, the determining of whether to re-operate the morning call alarm may include, when one of the divided amounts of the detected motion where no motion is present for a snooze time exists, determining an average of the divided amounts of the detected motion stored and comparing the average with a threshold value for the snooze time.

In an exemplary implementation, the determining of whether to re-operate the morning call alarm may include, when one of the divided amounts of the detected motion where no motion is present for a snooze time does not exist, terminating the morning call alarm.

In an exemplary implementation, the snooze function may be set or released by a user, and the snooze time may be set by the user.

According to another aspect of the present invention, a motion recognition device connectable with a mobile terminal via short range communication is provided. The device comprises a motion recognition sensor unit for, when a morning call alarm of the mobile terminal operates and a snooze function starts, detecting a motion of the additional unit using a motion recognition sensor connectable with the mobile terminal via the short range communication, a memory for dividing the detected motion based on a preset time interval, and for storing each of the divided amounts, a controller for determining each of the divided amounts of the motion stored to determine whether to re-operate the morning call alarm, and a communication unit for transmitting the determination as to whether to re-operate the morning call alarm to a controller of the mobile terminal.

According to another aspect of the present invention, a motion recognition device connectable with a mobile terminal via short range communication is provided. The device comprises a motion recognition sensor unit for, when a morning call alarm of the mobile terminal operates and a snooze function starts, detecting a motion of the additional unit using a motion recognition sensor connectable with the mobile terminal via the short range communication, and a communication unit for transmitting the detected motion to the mobile terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a mobile terminal for controlling a morning call function using a motion recognition sensor according to an exemplary embodiment of the present invention;

FIG. 2 is a flowchart illustrating a method for controlling a morning call function using a motion recognition sensor according to an exemplary embodiment of the present invention; and

FIG. 3 is a view illustrating a screen during an operation of a morning call function according to an exemplary embodiment of the present invention.

Throughout the drawings, like reference numerals will be understood to refer to like parts, components and structures.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

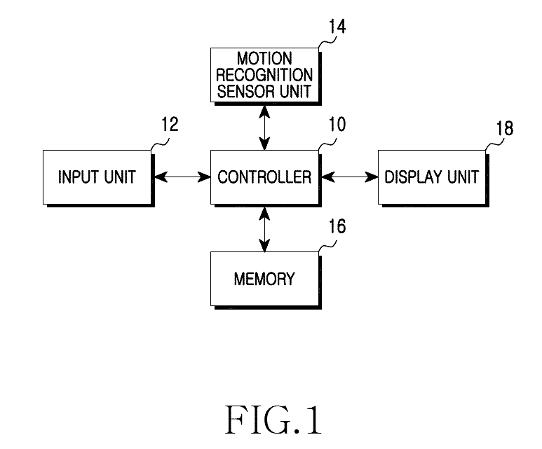

FIG. 1 is a block diagram illustrating a mobile terminal for controlling a morning call function using a motion recognition sensor according to an exemplary embodiment of the present invention.

Referring to FIG. 1, the mobile terminal includes a controller 10, an input unit 12, a motion recognition sensor unit 14, a memory 16, and a display unit 18.

The controller 10 controls overall operations of the mobile terminal for controlling a morning call function by detecting the motion of the mobile terminal using a motion recognition sensor. For example, when a morning call alarm operates and a snooze function starts, the controller 10 controls to terminate or re-operate the morning call function by detecting the motion of the mobile terminal using the motion recognition sensor unit 14, and determining each of the divided amounts of the detected motion stored in the memory 16 based on a preset time interval. In the following description, descriptions of a conventional process and control of the controller 10 are omitted.

The input unit 12 may include a plurality of numerical keys, function keys, navigation keys, a touch screen, and a touch pad, and transfers an input signal corresponding to at least one of the key, the touch screen, and the touch pad to the controller 10.

The motion recognition sensor unit 14 detects the motion of the mobile terminal using the motion recognition sensor. At this point, the recognition sensor may be one of an acceleration sensor, a gyro sensor, and the like, for example.

The display unit 18 receives a control signal of the controller 10 to output the screen of the mobile terminal.

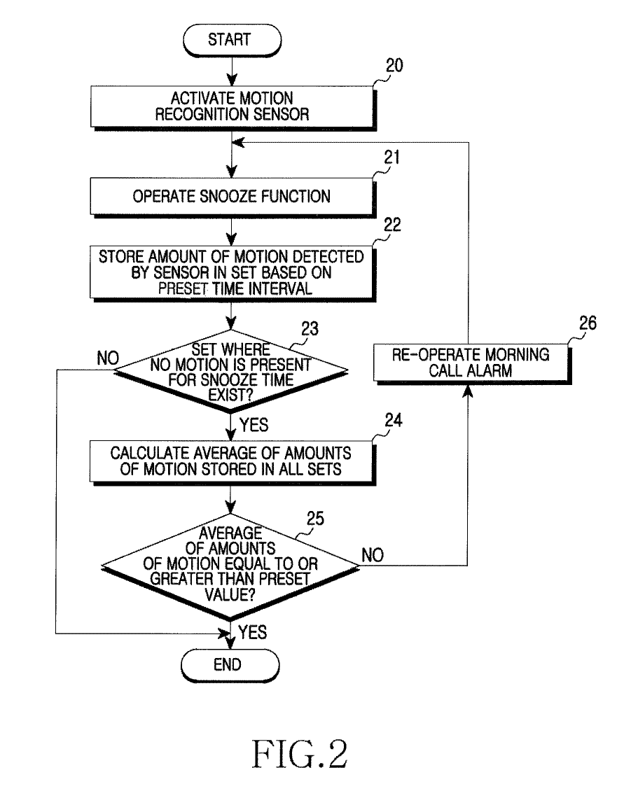

An operation of an exemplary embodiment of the present invention will be described in more detail with reference to FIG. 2.

FIG. 2 is a flowchart illustrating a method for controlling a morning call function using a motion recognition sensor according to an exemplary embodiment of the present invention.

Referring to FIG. 2, when a morning call alarm operates, the controller 10 outputs a control signal activating the motion recognition sensor unit 14 provided to the mobile terminal to activate the motion recognition sensor in step 20. In step 21, a snooze function operates, and in step 22, the controller 10 stores each of the divided amounts of the motion detected by the motion recognition sensor unit 14 based on a preset time interval. For example, in a case where the preset time interval is 30 seconds, the controller 10 stores the amount of motion detected for 30 seconds as one of the divided amounts corresponding to 30 seconds in the memory 16. In step 23, the controller 10 searches for one of the divided amounts stored in the memory 16 where no motion is present while the snooze function operates. When one of the divided amounts where no motion is present does not exist, the controller 10 terminates a morning call operation. In contrast, when one of the divided amounts where no motion is present exists, the controller 10 determines an average of the divided amounts of the detected motion stored in the memory for a snooze time in step 24, and compares the average with a threshold value in step 25. At this point, when the average is equal to or greater than the threshold value, the controller 10 terminates the morning call operation. In contrast, when the average is less than the threshold value, the controller 10 controls to re-operate the morning call function to ring a morning call again. Here, the snooze function may be set or released by a user.

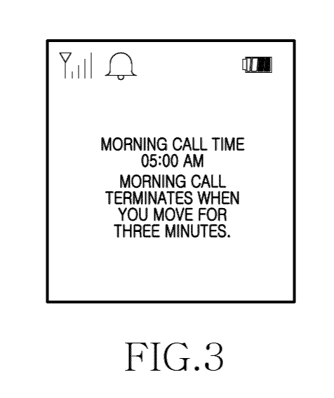

FIG. 3 is a view illustrating a screen during an operation of a morning call function according to an exemplary embodiment of the present invention.

Referring to FIG. 3, when a morning call rings at 5 in the morning, the motion recognition sensor is activated and the snooze function operates. At this point, the display unit 18 outputs a guide message saying that a morning call terminates when the mobile terminal is moved for three minutes. Here, the time of three minutes denotes a snooze time, which may be set by a user. At this point, assuming that a preset time interval is 30 seconds, a total of six time intervals are generated to store amounts of motion of the mobile terminal in the memory 16. After that, the controller 10 searches for the amounts of motion of the six time intervals stored in the memory 16, and when certain amounts of motion exist in all the six time intervals, terminates the morning call operation. However, when a certain amount of motion does not exist in at least onetime interval, the controller 10 determines an average of amounts of motion stored in the six time intervals and compares the average with the threshold value. When the average is equal to or greater than the threshold value, the controller 10 terminates the morning call operation. When the average is less than the threshold value, the controller 10 rings a morning call alarm again.

The construction and operation of a morning call control method of a mobile terminal using a motion recognition sensor and an apparatus using the same according to an exemplary embodiment of the present invention may be provided as described above. Though the present invention has been described with reference to exemplary embodiments thereof, various modifications may be made without departing from the scope of the present invention. For example, when a morning call starts and a snooze function operates, an application is executed to perform an operation shown through the display unit 18. At this point, when the application obtains a preset score or more, or performs an operation which completely matches with the operation shown through the display unit 18, the morning call operation may terminate. Also, the motion recognition sensor may be realized using a gyro sensor or an acceleration sensor, or using them simultaneously.

In an exemplary implementation, an additional unit which may perform short range communication with a mobile terminal is provided. Accordingly, when the morning call alarm operates while a user is separated from the mobile terminal, the user performs an operation using the additional unit to control the morning call function operation of the mobile terminal through the short range communication with the mobile terminal. The additional unit may include a motion recognition sensor and may be realized using an armband. Also, the short range communication may be realized using Bluetooth communication or Near Field Communication (NFC). At this point, the additional unit detects motion through the motion recognition sensor and transmits the detected motion to the mobile terminal, or determines an amount of the detected motion and determines whether to re-operate a morning call alarm of the mobile terminal to transmit a control signal as to whether to re-operate the morning call alarm to the mobile terminal. Also, at this point, the mobile terminal may include a communication unit for the short range communication with the additional unit.

To address the above-described limitation, an exemplary embodiment of the present invention may provide a mobile terminal for, when a user performs motion with the mobile terminal for a preset time, detecting the motion to maintain or terminate the operation of a morning call function.

Certain aspects of the present invention can also be embodied as computer readable code on a computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a morning call operation of a mobile terminal, the method comprising:
when a morning call alarm of the mobile terminal rings and a snooze function starts, detecting a motion using a motion recognition sensor of the mobile terminal;
dividing the detected motion based on a preset time interval and storing each of the divided amounts of the detected motion; and
determining each of the divided amounts of the detected motion stored for a snooze time to determine whether to re-operate the morning call alarm.

2. The method of claim 1, wherein the snooze function is settable or releasable by a user.

3. The method of claim 1, wherein the motion recognition sensor comprises at least one of an acceleration sensor and a gyro sensor.

4. The method of claim 1, wherein the determining of whether to re-operate the morning call alarm comprises, when one of the divided amounts of the detected motion where no motion is present for the snooze time exists, determining an average of the divided amounts of the detected motion stored and comparing the average with a threshold value for the snooze time.

5. The method of claim 4, further comprising:
when the average is equal to or greater than the threshold value as a result of the comparison, terminating the morning call operation.

6. The method of claim 4, further comprising:
when the average is less than the threshold value as a result of the comparison, re-operating the morning call operation.

7. The method of claim 1, wherein the determining of whether to re-operate the morning call alarm comprises, when one of the divided amounts of the detected motion where no motion is present for the snooze time does not exist, terminating the morning call operation.

8. A method for controlling a morning call operation of a mobile terminal, the method comprising:
when a morning call alarm of the mobile terminal rings and a snooze function starts, detecting a motion using a motion recognition sensor of an additional unit connectable with the mobile terminal via short range communication;
dividing the detected motion based on a preset time interval and storing each of the divided amounts of the detected motion;
determining each of the dived amounts of the detected motion stored for a snooze time to determine whether to re-operate the morning call alarm; and
transmitting the determination as to whether to re-operate the morning call alarm to the mobile terminal.

9. The method of claim 8, wherein the short range communication comprises at least one of Bluetooth communication and Near Field Communication (NFC).

10. A method for controlling a morning call operation of a mobile terminal, the method comprising:
when a morning call alarm of the mobile terminal rings and a snooze function starts, detecting a motion using a motion recognition sensor of an additional unit connectable with the mobile terminal via short range communication;
transmitting the detected motion to the mobile terminal;
dividing, by the mobile terminal, the motion transmitted from the additional unit based on a preset time interval, and storing each of the divided amounts; and
determining each of the divided amounts of the motion stored for a snooze time to determine whether to re-operate the morning call alarm.

11. The method of claim 10, wherein the short range communication comprises at least one of Bluetooth communication and Near Field Communication (NFC).

12. The method of claim 10, wherein the detecting of the motion using the motion recognition sensor of the additional unit comprises, when the mobile terminal requests, detecting the motion by the additional unit.

13. The method of claim 10, wherein the detecting of the motion using the motion recognition sensor of the additional unit comprises detecting the motion based on the preset time interval.

14. The method of claim 10, wherein the detecting of the motion using the motion recognition sensor of the additional unit comprises detecting the motion continuously.

15. The method of claim 10, wherein the additional unit comprises an armband.

16. A mobile terminal comprising:
a display unit for displaying a screen of the mobile terminal;
a motion recognition sensor unit for, when a morning call alarm operates and a snooze function starts, detecting a motion of the mobile terminal using a motion recognition sensor;
a memory for dividing the detected motion based on a preset time interval and storing each of the divided amounts of the detected motion; and
a controller for determining each of the divided amounts of the detected motion stored to determine whether to re-operate the morning call alarm.

17. The mobile terminal of claim 16, wherein the snooze function is settable or releasable by a user.

18. The mobile terminal of claim 16, wherein the motion recognition sensor comprises at least one of an acceleration sensor and a gyro sensor.

19. The mobile terminal of claim 16, wherein, when one of the divided amounts of the motion where no motion is present for a snooze time exists, the controller determines an average of the divided amounts of the motion stored and compares the average with a threshold value for the snooze time.

20. The mobile terminal of claim 19, wherein, when the average is equal to or greater than the threshold value as a result of the comparison, the controller terminates the morning call alarm.

21. The mobile terminal of claim 19, wherein, when the average is less than the threshold value as a result of the comparison, the controller re-operates the morning call alarm.

22. The mobile terminal of claim 16, wherein, when one of the divided amounts of the motion where no motion is present for a snooze time does not exist, the controller terminates a morning call operation.

23. A motion recognition device connectable with a mobile terminal via short range communication, the device comprising:
a motion recognition sensor unit for, when a morning call alarm of the mobile terminal operates and a snooze function starts, detecting a motion of the additional unit using a motion recognition sensor connectable with the mobile terminal via the short range communication;
a memory for dividing the detected motion based on a preset time interval, and for storing each of the divided amounts;
a controller for determining each of the divided amounts of the motion stored to determine whether to re-operate the morning call alarm; and
a communication unit for transmitting the determination as to whether to re-operate the morning call alarm to a controller of the mobile terminal.

24. The device of claim 23, wherein the motion recognition sensor comprises at least one of an acceleration sensor and a gyro sensor.

25. The device of claim 23, wherein the short range communication comprises at least one of Bluetooth communication and Near Field Communication (NFC).

26. The device of claim 23, further comprising:
an armband for fastening the device to a arm of a user.

27. A motion recognition device connectable with a mobile terminal via short range communication, the device comprising:
a motion recognition sensor unit for, when a morning call alarm of the mobile terminal operates and a snooze function starts, detecting a motion of the additional unit using a motion recognition sensor connectable with the mobile terminal via the short range communication; and
a communication unit for transmitting the detected motion to the mobile terminal.

28. The device of claim 27, wherein the motion recognition sensor comprises at least one of an acceleration sensor and a gyro sensor.

29. The device of claim 27, wherein the short range communication comprises at least one of Bluetooth communication and Near Field Communication (NFC).

30. The device of claim 27, further comprising:
an armband for fastening the device to a arm of a user.
